(19) United States
(12) Patent Application Publication
(10) Pub. No.: US 2011/0181492 A1
(43) Pub. Date: Jul. 28, 2011

(54) SCREEN SHARING APPARATUS, CONTROL METHOD THEREOF, PROGRAM AND SCREEN SHARING SYSTEM

(75) Inventor: Gakuya Soeda, Isehara-shi (JP)

(73) Assignee: CANON KABUSHIKI KAISHA, Tokyo (JP)

(21) Appl. No.: 12/985,494

(22) Filed: Jan. 6, 2011

(30) Foreign Application Priority Data
Jan. 26, 2010 (JP) 2010-014676

(51) Int. Cl. G09G 5/00

(52) U.S. Cl. 345/1.1

(57) ABSTRACT

The user controls selection of a display image to be shared for the granularity he wants. A processing method regarding sharing of a display image to be processed is determined by referring to a setting file which is stored in a storage medium and describes a processing method indicating whether to permit sharing of a display image. Processing regarding sharing of the display image to be processed is executed in accordance with the determined processing method.

### BACKGROUND OF THE INVENTION

1. Field of the Invention

The present invention relates to a screen sharing apparatus which shares part or all of a display image on a display screen by displaying it on the display screen of another information processing apparatus, a control method thereof, a program, and a screen sharing system.

2. Description of the Related Art

Recent development of networks is expanding the use range of a screen sharing apparatus utilizing a computer system. One form of the screen sharing apparatus is a system formed from a combination of the following two functions.

One is a display function of transmitting the screen display contents of a screen sharing server apparatus to a screen sharing client apparatus and displaying them on the screen sharing client apparatus side. With this display function, the user of the screen sharing client apparatus can confirm the current display state of the screen sharing server apparatus. The other is an operation function of transmitting, to the screen sharing server apparatus, the operation contents of a mouse/keyboard with respect to the received image display region of the screen sharing client apparatus, and reproducing the same operation on the screen sharing server apparatus side. With this operation function, the user of the screen sharing client apparatus can remote-operate the screen sharing server apparatus.

As a screen display content generation method, there has been proposed a screen sharing apparatus which shares screen display contents for each application (for example, Japanese Patent Laid-Open No. 2005-352795).

However, in the technique described in Japanese Patent Laid-Open No. 2005-352795, the display target can be selected only for each application, and no sharing setting can be made individually for a plurality of windows provided by the same application. Also, no sharing setting can be made for some windows provided by an unshared application. This technique is therefore unsatisfactory because the user may perform sharing control for granularity other than an application.

### SUMMARY OF THE INVENTION

The present invention provides a screen sharing apparatus which allows the user to control selection of a display image to be shared for granularity he wants, a control method thereof, a program, and a screen sharing system.

According to the first aspect of the present invention, there is provided a screen sharing apparatus which shares at least part of a display image on a display screen of the screen sharing apparatus by displaying the display image on a display screen of an information processing apparatus different from the screen sharing apparatus, the screen sharing apparatus comprising: a storage unit adapted to store a setting file which describes a processing method indicating whether to permit sharing of a display image; a determination unit adapted to determine a processing method regarding sharing of a display image to be processed, by referring to the setting file stored in the storage unit; and an execution unit adapted to execute processing regarding sharing of the display image to be processed, in accordance with the processing method determined by the determination unit.

According to the second aspect of the present invention, there is provided a method of controlling a screen sharing apparatus which shares at least part of a display image on a display screen of the screen sharing apparatus by displaying the display image on a display screen of an information processing apparatus different from the screen sharing apparatus, the method comprising: a determination step of determining a processing method regarding sharing of a display image to be processed, by referring to a setting file which is stored in a storage medium and describes a processing method indicating whether to permit sharing of a display image; and an execution step of executing processing regarding sharing of the display image to be processed, in accordance with the processing method determined in the determination step.

According to the third aspect of the present invention, there is provided a program which is stored in a computer readable storage medium and makes a computer control sharing at least part of a display image on a display screen of the computer by displaying the display image on a display screen of an information processing apparatus different from the computer, the program causing the computer to function as a storage unit adapted to store a setting file which describes a processing method indicating whether to permit sharing of a display image, a determination unit adapted to determine a processing method regarding sharing of a display image to be processed, by referring to the setting file stored in the storage unit, and an execution unit adapted to execute processing regarding sharing of the display image to be processed, in accordance with the processing method determined by the determination unit.

According to the fourth aspect of the present invention, there is provided a screen sharing system comprising a screen sharing server and a screen sharing client, the screen sharing server sharing at least part of a display image on a display screen of the screen sharing server by displaying the display image on a display screen of the screen sharing client, the screen sharing server comprising: a storage unit adapted to store a sharing rule which describes a processing method indicating whether to permit sharing of a display image; a determination unit adapted to determine a processing method regarding sharing of a display image to be processed, by referring to the sharing rule stored in the storage unit; an execution unit adapted to execute processing regarding sharing of the display image to be processed, in accordance with the processing method determined by the determination unit; and a transmission unit adapted to transmit, to the screen sharing client, a shared image of the display image to be processed that is generated in accordance with execution by the execution unit, the screen sharing client comprising: a reception unit adapted to receive the shared image transmitted by the transmission unit from the screen sharing server; and a display unit adapted to display the shared image received by the reception unit.

Further features of the present invention will be apparent from the following description of exemplary embodiments with reference to the attached drawings.

### BRIEF DESCRIPTION OF THE DRAWINGS

FIG. 1 is a view showing the overall configuration of a screen sharing system in the first embodiment;

FIG. 2 is a block diagram showing the arrangement of a screen sharing server 111 in the first embodiment;

FIG. 3 is a view showing the display state of the screen sharing system in the first embodiment;

FIG. 4 is a view showing the display state of the screen sharing system in the first embodiment;

FIG. 5 is a view showing the display state of the screen sharing system in the first embodiment;

FIG. 6 is a flowchart showing the processing sequence of the screen sharing server 111 in the first and second embodiments;

FIG. 7 is a view showing the display state of the screen sharing system in the first embodiment;

FIG. 8 is a view showing the display state of the screen sharing system in the first embodiment;

FIG. 9 is a table exemplifying sharing rules used in the screen sharing server 111 in the second embodiment;

FIG. 10 is a flowchart showing the processing sequence of a screen sharing server 111 in the third embodiment;

FIG. 11 is a table exemplifying sharing rules updated by the screen sharing server 111 in the third embodiment;

FIG. 12 is a flowchart showing the processing sequence of a screen sharing server 111 in the fourth embodiment;

FIG. 13 is a view showing the display state of a screen sharing system in the fourth embodiment;

FIG. 14 is a view showing the display state of the screen sharing system in the fourth embodiment;

FIG. 15 is a view showing the display state of the screen sharing system in the fourth embodiment; and

FIG. 16 is a view showing the display state of the screen sharing system in the fourth embodiment.

### DESCRIPTION OF THE EMBODIMENTS

A preferred embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

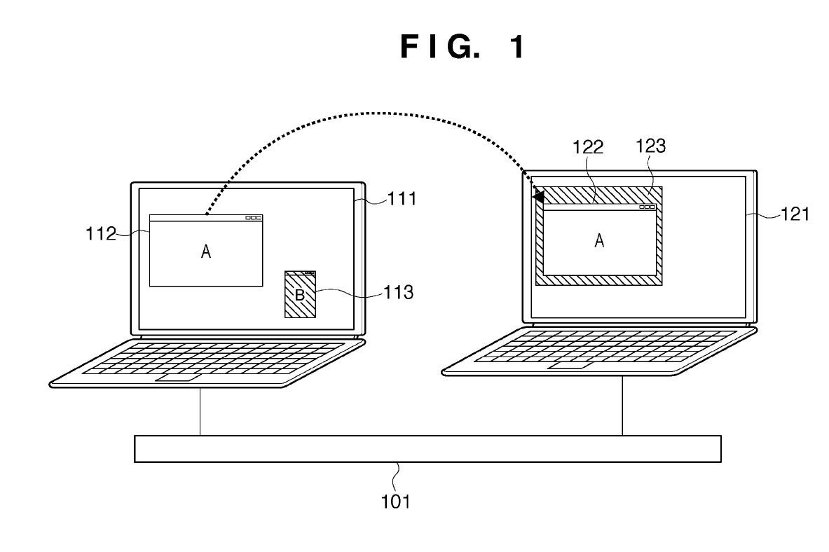

FIG. 1 is a view showing the overall configuration of a screen sharing system in the first embodiment.

A first terminal 111 is the core of the screen sharing system. The first terminal 111 determines a region to be shared (image to be shared), and generates and transmits a shared image. The first terminal 111 has a function of simultaneously executing a plurality of types of applications, and displaying windows provided by these applications on the display screen of the first terminal 111. In FIG. 1, windows 112 and 113 are displayed on the first terminal 111.

Note that the first terminal 111 stores a screen sharing server program functioning as a screen sharing server (to be described later), and can execute it. The first terminal 111 can acquire an image (shared image) shared with another terminal from part or all of a window serving as an image displayed on the display screen of the first terminal 111. Further, the first terminal 111 can transmit the acquired shared image to another terminal via a network 101. In the first embodiment, assume that the window 112 is shared.

A second terminal 121 receives and displays a shared image in the screen sharing system. The second terminal 121 stores a screen sharing client program functioning as a screen sharing client (to be described later), and can execute it. The second terminal 121 has a reception function of receiving a screen sharing server control result via the network 101. Further, the second terminal 121 has a display function of ensuring a display region 123 for displaying a received image (shared image) on the display screen of the second terminal 121, and displaying a received shared image 122 in the display region 123. The shared image is received from the screen sharing server via this reception function.

Note that the number of first terminals 111 or second terminals 121 is not limited to one and is arbitrary. One terminal can transmit a shared image to a plurality of terminals, or one terminal can receive shared images from a plurality of terminals. One terminal may simultaneously have the functions of the first terminal 111 and second terminal 121, and simultaneously execute the screen sharing server function and screen sharing client function.

In this configuration according to the first embodiment, the first terminal 111 shares, with the second terminal 121, only a window the user wants, among a plurality of windows displayed on the first terminal 111. For descriptive convenience, the first terminal 111 will be called a screen sharing server, and the second terminal 121 will be called a screen sharing client. The screen sharing server means an apparatus having a server function of generating a shared image, and providing it to another apparatus (screen sharing client). The screen sharing client means an apparatus having a client function of receiving a shared image provided from the screen sharing server, and displaying it on the monitor of the screen sharing client.

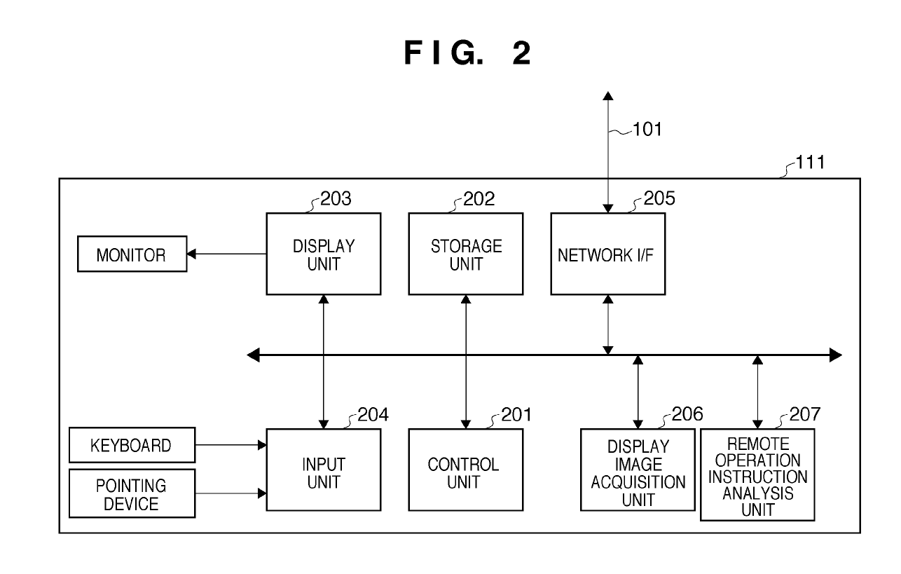

FIG. 2 is a block diagram showing the arrangement of the screen sharing server 111 in the first embodiment.

Note that the screen sharing server 111 in the first embodiment is built from a general-purpose information processing apparatus such as a personal computer. The screen sharing client 121 is also built from an information processing apparatus equivalent to the screen sharing server 111.

Referring to FIG. 2, a control unit 201 controls the overall apparatus, and is formed from a CPU or the like. A storage unit 202 stores a boot program, BIOS, various applications, the screen sharing server program, data files, and the like. The storage unit 202 is formed from storage media such as a ROM, RAM, and HDD. A display unit 203 incorporates a video memory, and generates and outputs video signals for rendering and display under the control of the control unit 201. The display unit 203 displays the contents of the video memory on a monitor connected to the display unit 203. An input unit 204 has a function of controlling a keyboard and pointing device which function as the standard input devices of the screen sharing server. The input unit 204 receives an operation instruction from a connected input device such as a keyboard or mouse, and executes various processes in accordance with the operation instruction. A network I/F 205 transmits and receives data via the network 101, and is formed from, for example, a network card.

A display image acquisition unit 206 acquires a display image from the display unit 203 and generates a shared image. The display image acquisition unit 206 transmits the generated shared image to the screen sharing client 121 via the network I/F 205. A remote operation instruction analysis unit 207 receives a remote operation instruction via the network I/F 205, and converts it into an operation instruction to be processed by the input unit 204. Further, the remote operation instruction analysis unit 207 transfers the converted operation instruction to the input unit 204, and generates an instruction to execute the corresponding operation similarly to a local operation.

Note that the display image acquisition unit 206 and remote operation instruction analysis unit 207 are arranged independently as main building elements in the screen sharing server 111, but may be contained in another building element such as the control unit 201.

In this arrangement, when the screen sharing server 111 which provides the window 112 as a sharing target (processing target) is connected to the screen sharing client 121 via the network 101, screen sharing starts. The display image acquisition unit 206 acquires, from the display unit 203, image data from a memory space in the video memory that corresponds to a coordinate region where the window 112 is displayed. If necessary, the display image acquisition unit 206 compresses the image data, and transmits the compressed image data to the screen sharing client 121 via the network I/F 205. The screen sharing client 121 displays the received image data in the display region 123 of the screen sharing client 121. As a result, the user of the screen sharing client 121 can display the image of the window 112 of the screen sharing server 111, and perform an operation for remote operation.

In this arrangement, the screen sharing server 111 checks the display state of its window. If a new window has been generated, the screen sharing server 111 determines whether to share it as a control content. If the screen sharing server 111 determines to share the window, it uses the display image acquisition unit 206 to acquire image data of the window and transmit it to the screen sharing client 121, thereby sharing the window with the screen sharing client 121.

In the first embodiment, an input instruction to determine sharing needs to be set in advance. In the first embodiment, this setting (sharing condition) is described as a setting file and saved in advance in the storage unit 202. Especially in the first embodiment, in the above-described arrangement, a parameter is set in this setting file to allow the user of the screen sharing server 111 to determine whether to individually permit execution of sharing when a new window is displayed. This parameter is used to display a sharing execution confirmation dialog (inquiry screen) to be described later.

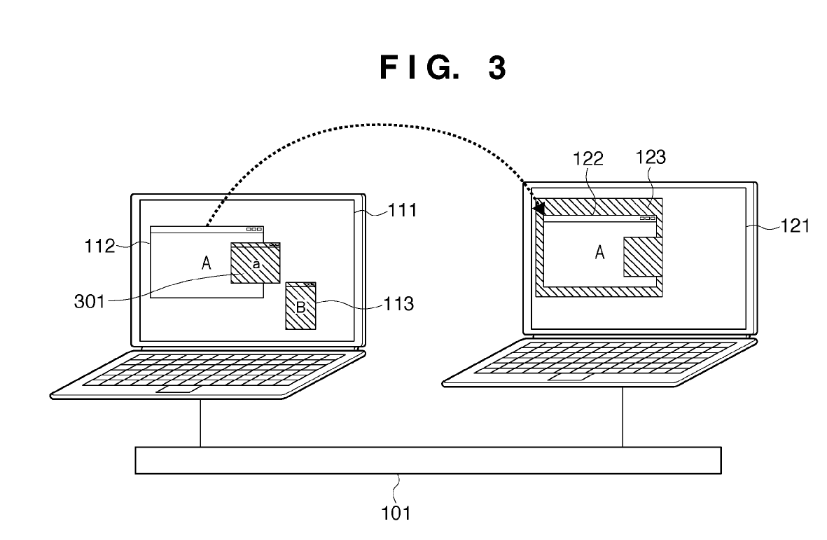

FIG. 3 is a view showing a state in which a new window 301 is opened on the screen sharing server 111 in the first embodiment.

When the new window 301 is generated, it is not a sharing target in an initial state and is handled as an unshared region. When the new window 301 overlaps the shared window 112, an overlapping region covered with the new window 301 in the display region of the shared window 112 is excluded from the sharing target. Hence, the shared image 122 is displayed on the screen sharing client 121 while part of the shared window 112 is grayed out, as shown in FIG. 3.

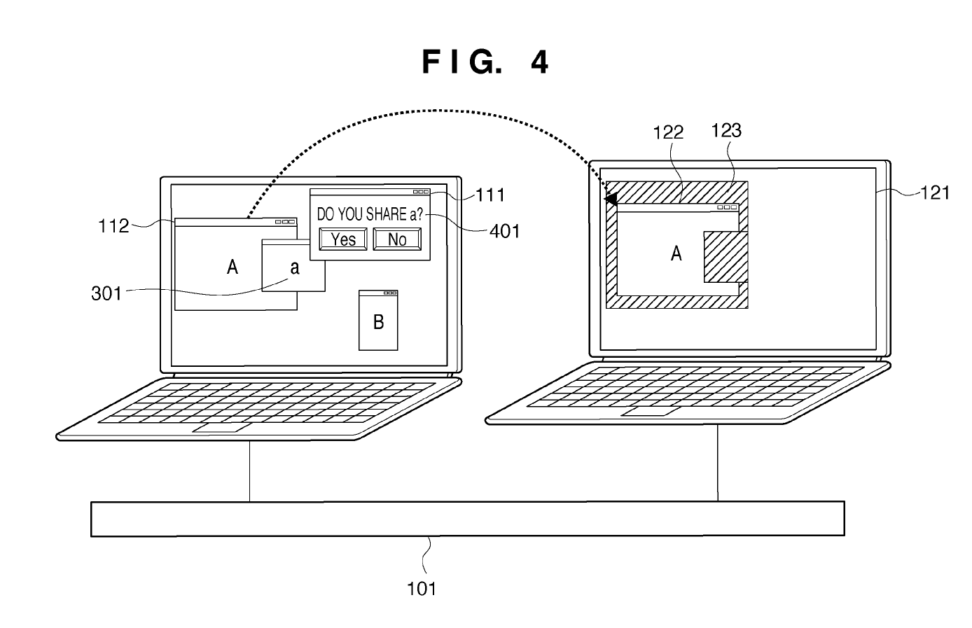

After that, the screen sharing server 111 detects that the new window 301 has been generated, and displays a sharing execution confirmation dialog 401 (FIG. 4) for inquiring of the user whether to permit sharing. FIG. 4 shows a state in which the sharing execution confirmation dialog 401 is displayed. The user can click either the “Yes” or “No” button in the sharing execution confirmation dialog 401 to input an input instruction to the screen sharing server 111 about whether to execute sharing of the new window 301.

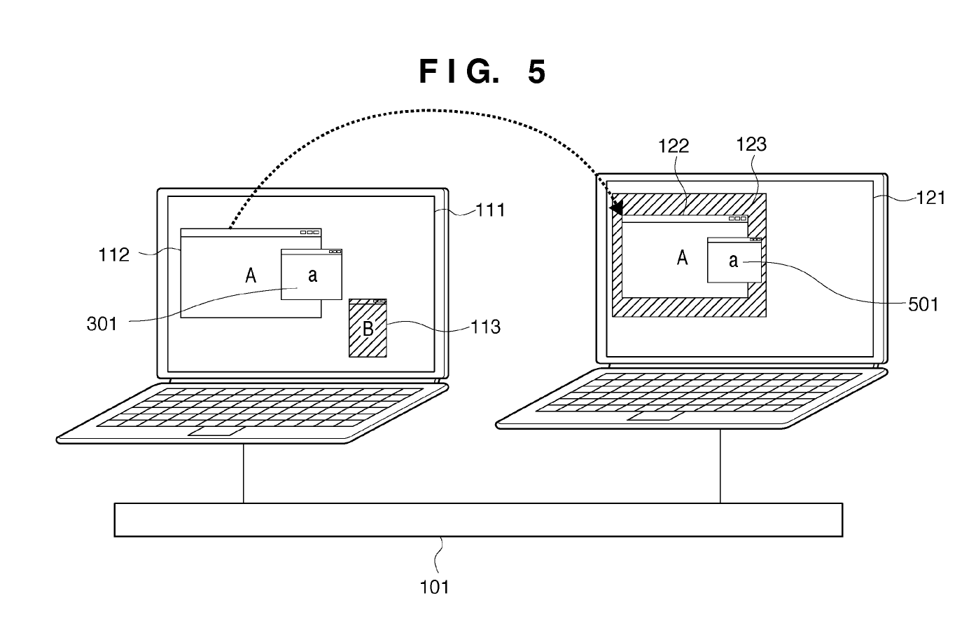

FIG. 5 shows the result of selecting “Yes” by the user. The new window 301 becomes a sharing target region together with the shared window 112. The display image acquisition unit 206 acquires corresponding image data and transmits it to the screen sharing client 121. Then, the screen sharing client 121 displays, in the display region 123, a composition of the shared image 122 corresponding to the shared window 112 and an additional shared image 501 corresponding to the additionally shared new window 301.

In the first embodiment, the received additional shared image 501 is reduced and displayed because the additional shared image 501 corresponding to the new window 301 extends outside the display region 123 at a reduction ratio before additional sharing. However, the additional shared image 501 may be displayed without reduction, or a scroll bar may be displayed to display the extending portion.

To the contrary, when the user selects “No” as an input instruction, no window is additionally shared, and the screen of the screen sharing client 121 remains unchanged from the state of FIG. 3.

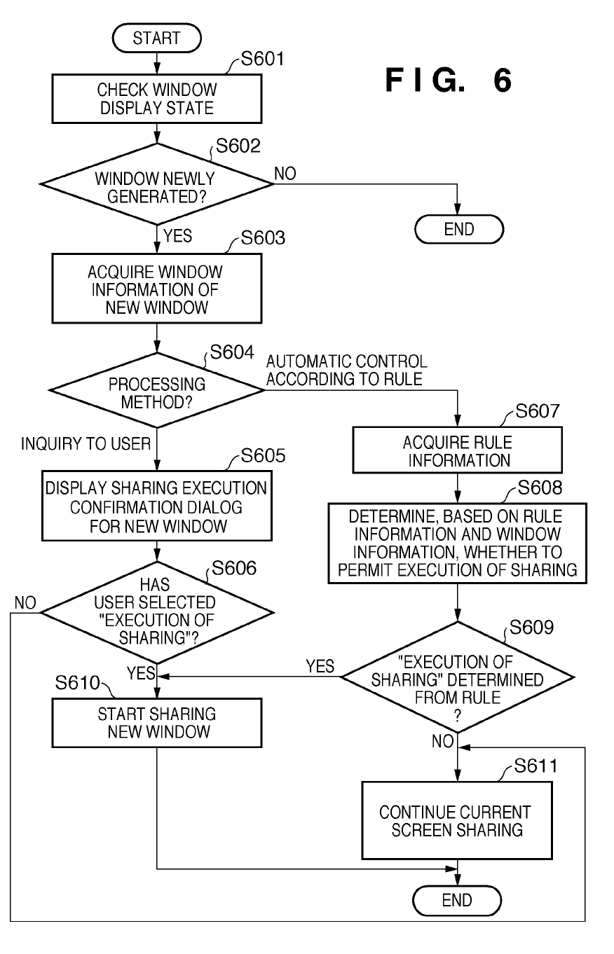

The concrete processing contents of the screen sharing server 111 in the first embodiment will be explained with reference to the flowchart of FIG. 6.

FIG. 6 is a flowchart showing the processing sequence of the screen sharing server 111 when a new window is displayed in the first embodiment.

Note that the flowchart in FIG. 6 also serves as a flowchart in the second embodiment (to be described later). Steps S607 to S609 correspond to processes to be described in the second embodiment, and will be explained later.

In step S601, the control unit 201 checks the display state of each window. In step S602, the control unit 201 determines whether a new window has been generated. If no new window has been generated (NO in step S602), the process ends. If a new window has been generated (YES in step S602), the process advances to step S603.

In step S603, the control unit 201 acquires window information of the new window such as the display region coordinates of the new window. In step S604, the control unit 201 reads (refers to) a new window processing method from the setting file stored in advance in the storage unit 202. In step S604, the control unit 201 branches the process to step S605 or S607 based on the contents of the setting file.

In the first embodiment, the input instruction “inquiry to the user” via the sharing execution confirmation dialog is set in the setting file, as described above.

In step S605, therefore, the control unit 201 generates the sharing execution confirmation dialog, and displays it on the monitor via the display unit 203 for the user. In step S606, the control unit 201 monitors an operation to the sharing execution confirmation dialog, and determines whether the user has selected “execution of sharing”, that is, has selected the YES button. If the user has selected execution of sharing as an input instruction (YES in step S606), that is, has selected the YES button, the control unit 201 starts sharing the new window as a control content in step S610. If the user has not selected execution of sharing as an input instruction (NO in step S606), the control unit 201 continues the current screen sharing in step S611 without adding the sharing target.

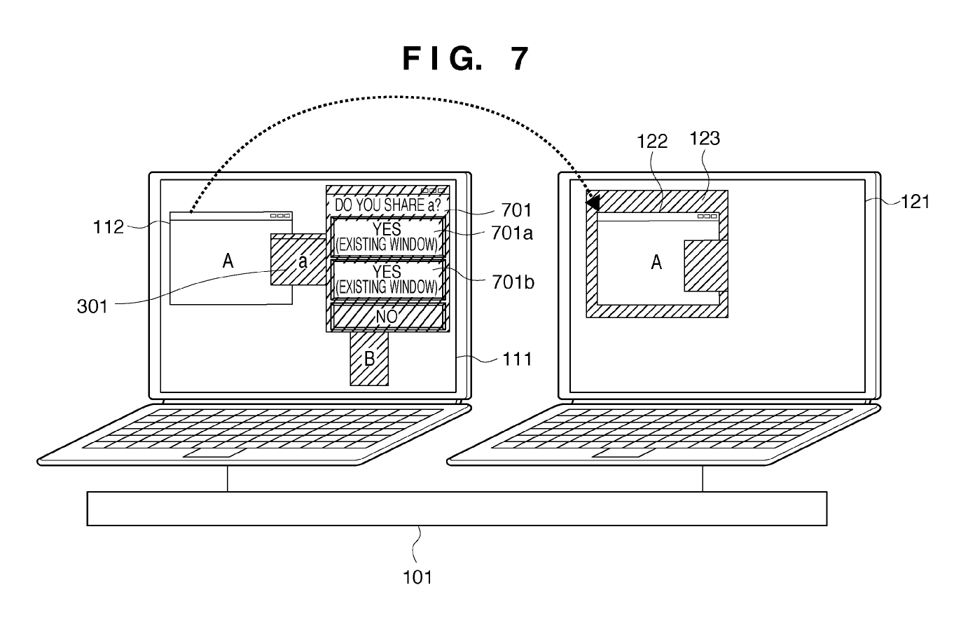

Note that the sharing execution confirmation dialog in step S605 is not limited to permission/inhibition of sharing, and may allow designating even another additional parameter to perform another control. FIG. 7 exemplifies a dialog when an additional parameter can be actually designated.

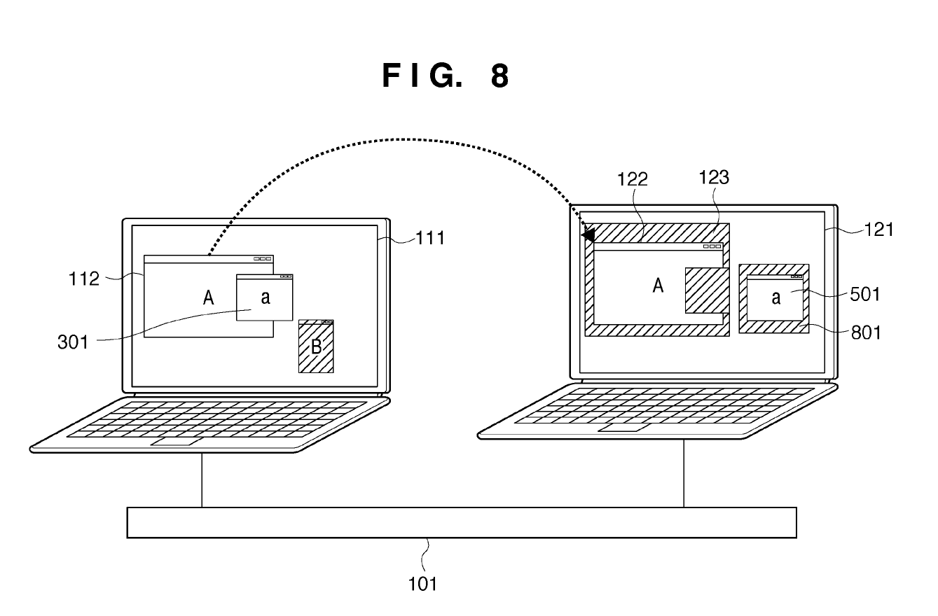

In FIG. 7, there are two choices (buttons) when executing sharing. One is “Yes (existing window)” 701a for adding a shared image to an existing window (=the display region 123) in the screen sharing client. The other is “Yes (new window)” 701b for generating a shared image for a new window in the screen sharing client, and individually displaying the shared image. When the user selects “Yes (existing window)”, the display result shown in FIG. 5 is obtained. When the user selects “Yes (new window)”, the display result shown in FIG. 8 is obtained. Referring to FIG. 8, the screen sharing client 121 newly generates a second display region 801 as a control content, and displays, in the second display region 801, the additional shared image 501 corresponding to the additionally shared new window 301.

As described above, according to the first embodiment, when a new window is generated, the user can freely select permission/inhibition of sharing, the sharing condition, and the like. The user intention can be accurately reflected in whether to permit sharing each window.

In this manner, the user intention can be appropriately reflected in determining whether to permit execution of sharing each window when sharing a screen for each display image (for example, window).

Note that the first embodiment has exemplified a window as a shared image. However, the present invention is not limited to this, and is applicable to any display image such as part of a window, a dialog, or a menu as long as the display image is displayed on the display screen and has a predetermined region capable of display control in the apparatus.

### Second Embodiment

In addition to the arrangement of the first embodiment, the second embodiment will describe an arrangement capable of automatically sharing only a window the user wants, without an inquiry to him when a new window is generated.

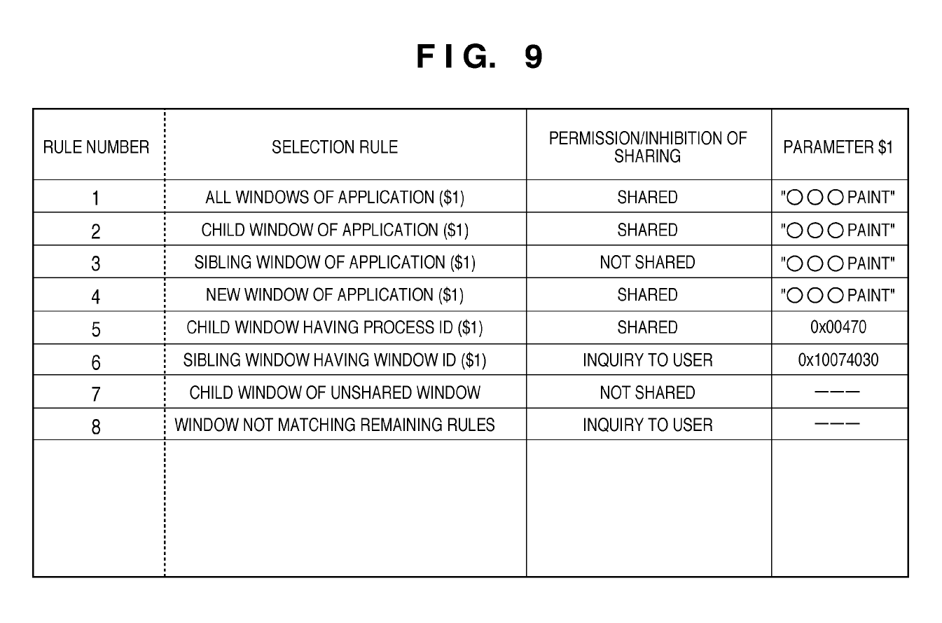

In this case, the user sets, in advance in the setting file, an input instruction to execute automatic sharing processing of automatically sharing a newly generated window with the screen sharing client when, for example, the newly generated window meets a designated condition. Particularly, the second embodiment implements automatic sharing processing by setting, in advance in the setting file, a sharing rule which defines a window sharing condition. FIG. 9 exemplifies sharing rules.

According to the sharing rules shown in FIG. 9, one or more pieces of rule information are written together for each record. To suppress the description amount, the concept of the parameter is introduced into the sharing rules in FIG. 9 so that selection of basic selection rules and parameters (permission/inhibition of sharing and an identifier for identifying a rule-applied target) for the rule can be described separately.

The selection rules here are, for example, all the windows, child window, and sibling window of a designated application.

Permission/inhibition of sharing includes “shared/not shared” and “inquiry to the user”.

The parameter (identifier for identifying a rule-applied target) includes an application name which specifies an application, and a process ID which identifies processing to be executed by an application.

A screen sharing server 111 selects rule information corresponding to a new window based on a sharing rule designated in the setting file, and determines, in accordance with contents designated in the rule information, whether to actually share the new window. Processing before and after determining whether to permit sharing is the same as that in the first embodiment.

Note that the basic selection rule and parameter need be neither set simultaneously nor set before activation of the screen sharing server program. The user suffices to set the selection rule and parameter at a convenient timing before actually generating a new window, and the rule is applied at the timing when the new window is actually generated. The rule description method is not limited to the format of FIG. 9, and any format is available as long as the rule can be described.

The concrete processing contents of the screen sharing server 111 in the second embodiment will be explained with reference to the flowchart of FIG. 6.

Similar to the first embodiment, in steps S601 to S603, the presence/absence of a new window is checked, and window information of a new window is collected. Then, in step S604, a control unit 201 reads the new window processing method from the setting file stored in a storage unit 202 (step S604). In the second embodiment, an input instruction “automatic control according to the rule” is described in the setting file. Thus, in step S607, the control unit 201 acquires rule information of the sharing rule stored in the storage unit 202.

In step S608, the control unit 201 determines, based on the acquired rule information and the window information of the new window, whether to permit execution of sharing.

In this determination, the window information acquired in step S603 is compared with various kinds of rule information of the sharing rules (FIG. 9) to search for corresponding rule information. Examples of the search parameter are

“The name of an application which has generated a new window”

“Does the parent window, child window, or sibling window of the newly generated window exist?”

“Is the parent window being shared?”

“Does the new window have a specific value as identification information such as a window ID or process ID?”

According to this description, the control unit 201 determines, for example,

“to share all windows regarding the specific application”

“not to share the child window of an unshared window”, or

“to share all windows regarding a process ID ‘0x00470’”

If the control unit 201 determines, based on the search result, to execute sharing (YES in step S609), the process advances to step S610, and the control unit 201 executes sharing of the new window. If the control unit 201 determines not to execute sharing (NO in step S609), the process advances to step S611, and the control unit 201 continues the current screen sharing without adding the sharing target.

In accordance with these processing results, the display state of a screen sharing client 121 changes as shown in FIGS. 3 to 5, similar to the first embodiment.

Note that the sharing rules shown in FIG. 9 enable even the setting “inquiry to the user” as a sharing permission/inhibition parameter, in addition to “shared”/“not shared”. For “inquiry to the user”, the sharing execution confirmation dialog is displayed to inquire of the user whether to permit sharing, like the first embodiment, implementing a flexible sharing policy which cannot be defined only by rules set in advance. A new parameter can also be added. For example, a parameter which designates “whether to open a new window on the screen sharing client side” can be added to enable sharing shown in FIG. 8.

As described above, according to the second embodiment, in addition to the effects described in the first embodiment, when a new window is generated, the user intention can be reflected in whether to permit sharing each window, without any labor such as display of the user inquiry dialog. If necessary, the inquiry dialog can be displayed to perform even fine sharing permission/inhibition control which cannot be defined only by rules.

### Third Embodiment

In the third embodiment, the first and second embodiments are extended to additionally write, as a rule to the sharing rules, the result of an inquiry to the user via a sharing execution confirmation dialog 401 so as to avoid repetitively making the same inquiry to the user.

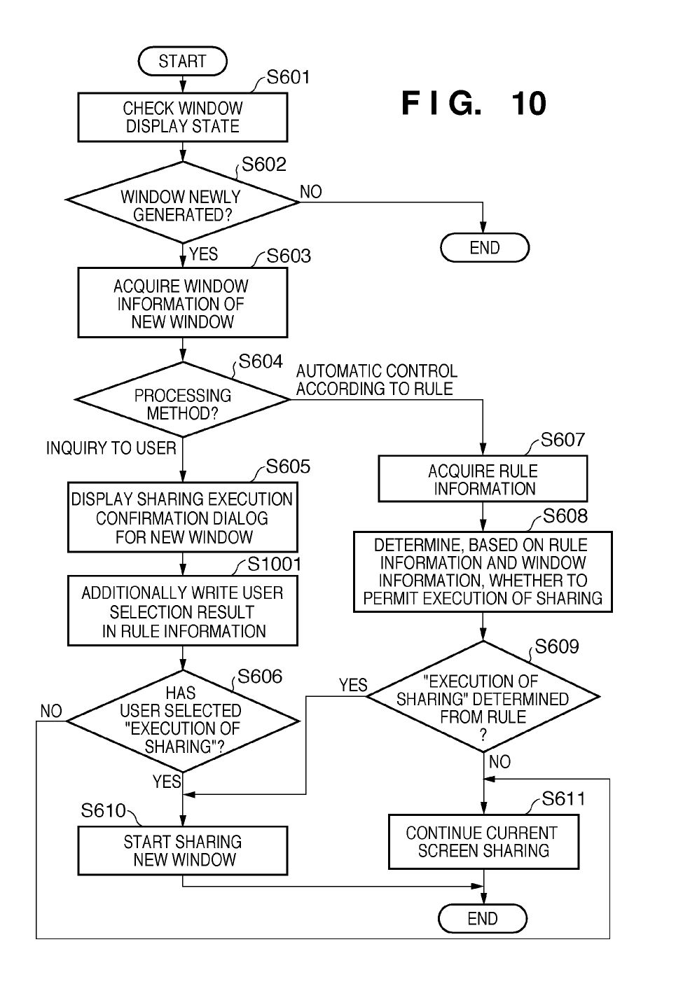

The concrete processing contents of a screen sharing server 111 in the third embodiment will be explained with reference to the flowchart of FIG. 10.

FIG. 10 shows an extension of the flowchart of FIG. 6 described in the first and second embodiments. Especially in FIG. 10, step S1001 is added as processing of reflecting, in the sharing rules, the result of determination by the user via the sharing execution confirmation dialog 401 in the screen sharing server 111.

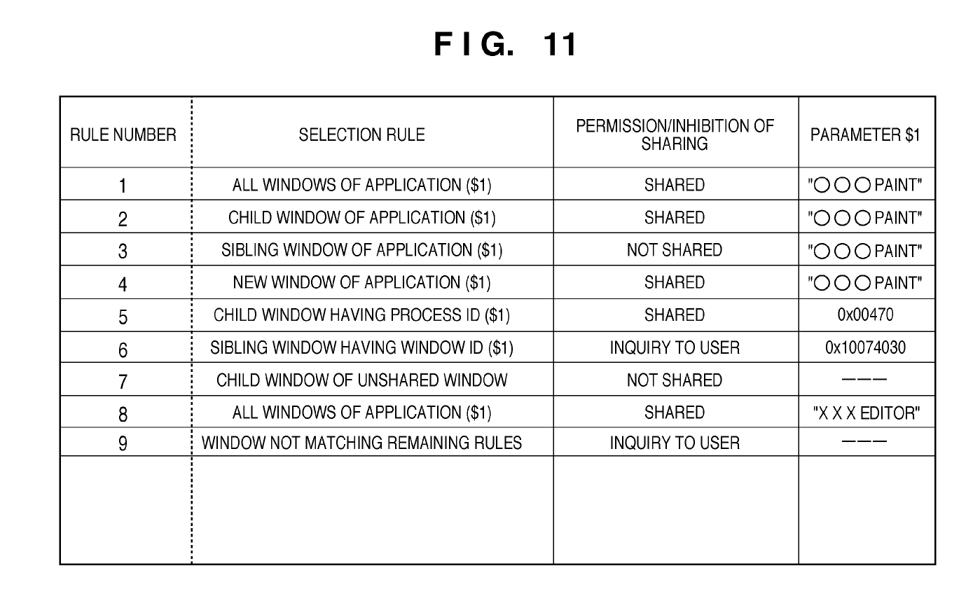

FIG. 11 shows updated sharing rules. In FIG. 11, a new rule is added eighth to the sharing rules in FIG. 9. As rule information, “selection rule”, “permission/inhibition of sharing”, and “parameter (application name)” are set.

If a window with the same condition is generated next time, sharing is automatically determined in steps S607 to S609. In this case, “shared” has been set in step S1001, so sharing of the window automatically starts from the next time. The screen of a screen sharing client 121 changes to display states as shown in FIGS. 3 to 5 and 8.

As described above, according to the third embodiment, in addition to the effects described in the first and second embodiments, a sharing condition once input by the user is not repetitively inquired to him, avoiding a cumbersome user operation of repetitively determining and designating whether to permit sharing.

### Fourth Embodiment

The fourth embodiment will describe an arrangement in which the above-described embodiments are expanded to determine whether to permit sharing only when a new window hides a shared window, as shown in FIG. 3. This determination can avoid execution of unnecessary determination processing.

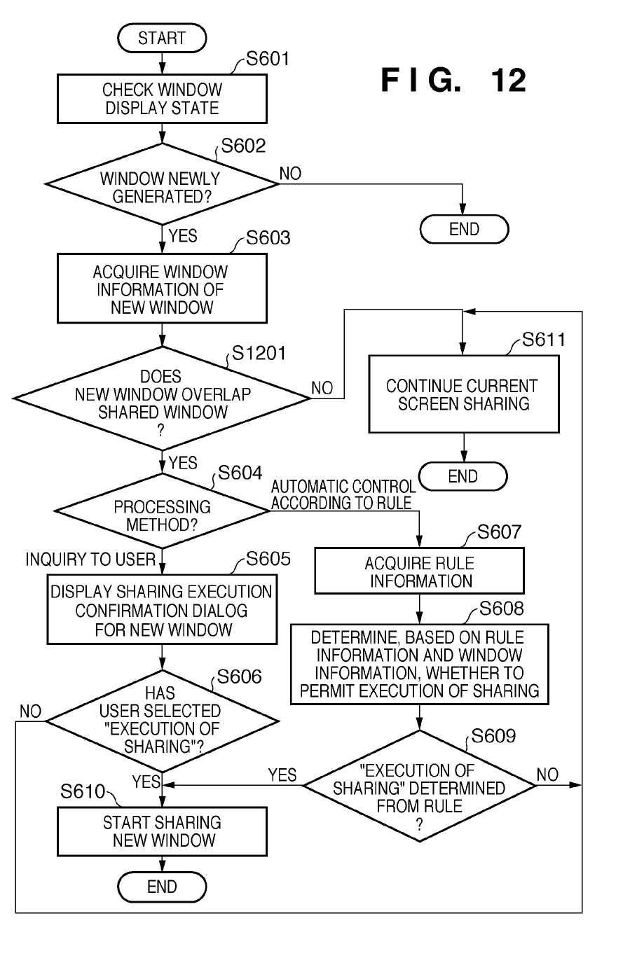

The concrete processing contents of a screen sharing server 111 in the fourth embodiment will be explained with reference to the flowchart of FIG. 12.

FIG. 12 shows an expansion of the flowchart of FIG. 6 described in the first and second embodiments to perform overlapping state acquisition determination processing. Particularly in FIG. 12, step S1201 is added as processing of confirming the overlapping state of a new window and shared window at the initial stage of sharing execution determination.

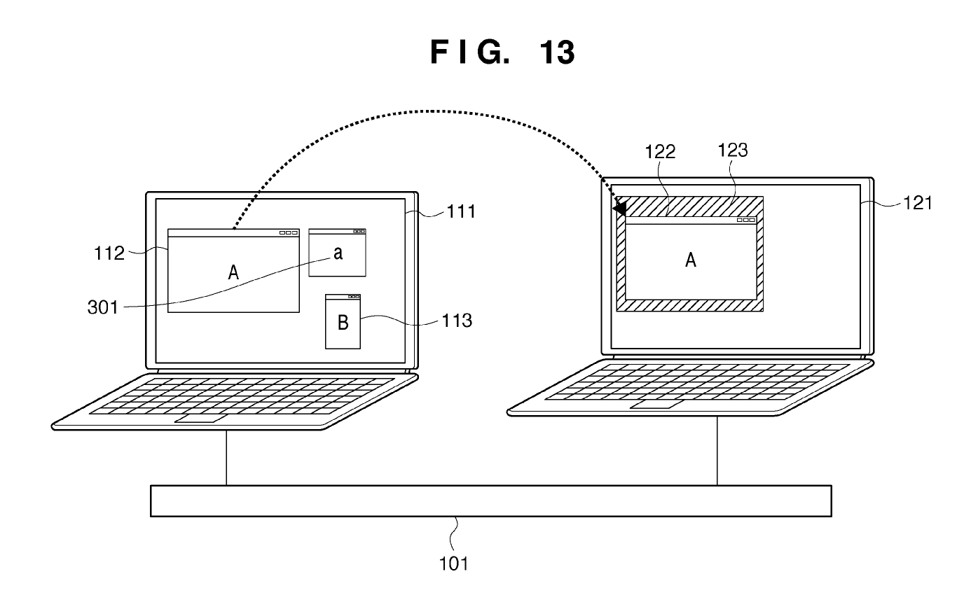

As a result of this processing, when a new window 301 as shown in FIG. 3 overlaps a shared window 112, the above-described embodiments are executed. When the new window 301 does not overlap the shared window 112, as shown in FIG. 13, the display state in FIG. 13 remains unchanged.

As described above, according to the fourth embodiment, in addition to the effects described in the first and second embodiments, whether to permit sharing is determined only when a new window overlaps a shared window, avoiding execution of unnecessary determination processing.

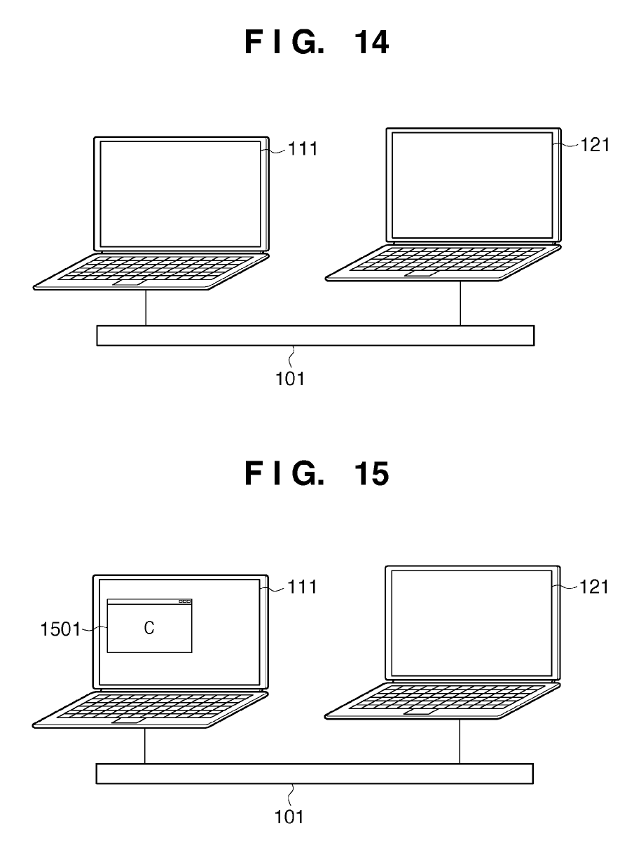

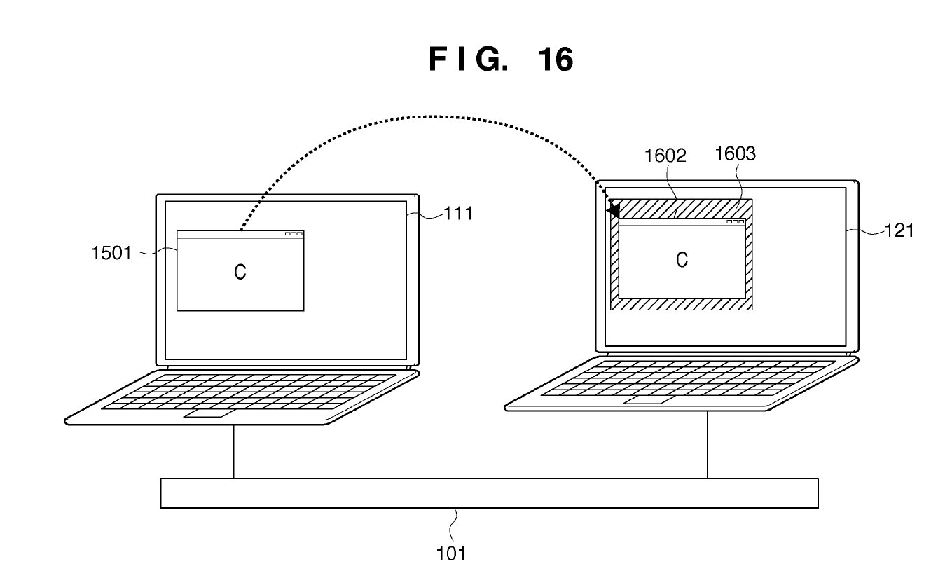

Although not described, the processes in all the embodiments can be executed even in a state in which no window is displayed on the screen sharing server 111. When the screen sharing server 111 newly generates a window 1501, as shown in FIG. 15, from a state in which no window is displayed as shown in FIG. 14, the processes are done in accordance with the above embodiments. Hence, a shared image 1603 of the window 1501 can be shared by displaying it in a display region 1602 of the screen sharing client 121, as shown in FIG. 16.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-014676, filed on Jan. 26, 2010, which is hereby incorporated by reference herein in its entirety.

What is claimed is:

1. A screen sharing apparatus which shares at least part of a display image on a display screen of the screen sharing apparatus by displaying the display image on a display screen of an information processing apparatus different from the screen sharing apparatus, the screen sharing apparatus comprising:
a storage unit adapted to store a setting file which describes a processing method indicating whether to permit sharing of a display image;
a determination unit adapted to determine a processing method regarding sharing of a display image to be processed, by referring to the setting file stored in said storage unit; and
an execution unit adapted to execute processing regarding sharing of the display image to be processed, in accordance with the processing method determined by said determination unit.

2. The apparatus according to claim 1, wherein said determination unit is executed when a newly generated display image is detected.

3. The apparatus according to claim 1, wherein when sharing, with the other information processing apparatus, the display image to be processed in the screen sharing apparatus in accordance with the processing method determined by said determination unit, said execution unit generates a shared image for sharing the display image to be processed, and transmits the shared image to the other information processing apparatus.

4. The apparatus according to claim 1, wherein said execution unit displays an inquiry screen to inquire whether to share the display image to be processed, in accordance with the processing method determined by said determination unit.

5. The apparatus according to claim 1, wherein
the display image includes a window displayed on the display screen, and
the setting file includes at least one of
a rule of automatically sharing/not sharing a child window of a shared window,
a rule of automatically sharing/not sharing a sibling window of a shared window,
a rule of automatically sharing/not sharing a window associated with an unshared window, and
a rule of automatically sharing/not sharing a window having specific identification information.

6. The apparatus according to claim 1, wherein
said execution unit displays an inquiry screen to inquire whether to share the display image to be processed, in accordance with the processing method determined by said determination unit, and
said storage unit additionally stores, in the setting file, a content of an inquiry result to the inquiry screen.

7. The apparatus according to claim 1, wherein said determination unit is executed when a newly generated display image overlaps a display image which has already been displayed.

8. A method of controlling a screen sharing apparatus which shares at least part of a display image on a display screen of the screen sharing apparatus by displaying the display image on a display screen of an information processing apparatus different from the screen sharing apparatus, the method comprising:
a determination step of determining a processing method regarding sharing of a display image to be processed, by referring to a setting file which is stored in a storage medium and describes a processing method indicating whether to permit sharing of a display image; and
an execution step of executing processing regarding sharing of the display image to be processed, in accordance with the processing method determined in the determination step.

9. A program which is stored in a computer readable storage medium and makes a computer control sharing at least part of a display image on a display screen of the computer by displaying the display image on a display screen of an information processing apparatus different from the computer, the program causing the computer to function as
a storage unit adapted to store a setting file which describes a processing method indicating whether to permit sharing of a display image,
a determination unit adapted to determine a processing method regarding sharing of a display image to be processed, by referring to the setting file stored in said storage unit, and
an execution unit adapted to execute processing regarding sharing of the display image to be processed, in accordance with the processing method determined by said determination unit.

10. A screen sharing system comprising a screen sharing server and a screen sharing client, said screen sharing server sharing at least part of a display image on a display screen of said screen sharing server by displaying the display image on a display screen of said screen sharing client,
said screen sharing server comprising:
a storage unit adapted to store a sharing rule which describes a processing method indicating whether to permit sharing of a display image;
a determination unit adapted to determine a processing method regarding sharing of a display image to be processed, by referring to the sharing rule stored in said storage unit;
an execution unit adapted to execute processing regarding sharing of the display image to be processed, in accordance with the processing method determined by said determination unit; and
a transmission unit adapted to transmit, to said screen sharing client, a shared image of the display image to be processed that is generated in accordance with execution by said execution unit,
said screen sharing client comprising:
a reception unit adapted to receive the shared image transmitted by said transmission unit from said screen sharing server; and
a display unit adapted to display the shared image received by said reception unit.
